(19) United States
(12) Patent Application Publication
(10) Pub. No.: US 2015/0240951 A1
(43) Pub. Date: Aug. 27, 2015

(54) ARRANGEMENT WITH A GAS SEAL

(71) Applicant: SIEMENS AKTIENGESELLSCHAFT, MÜNCHEN (DE)

(72) Inventor: Christian Kirchner, Moers (DE)

(21) Appl. No.: 14/425,411

(22) PCT Filed: Jul. 25, 2013
(86) PCT No.: PCT/EP2013/065687

§ 371 Date: Mar. 3, 2015

(30) Foreign Application Priority Data
Sep. 7, 2012 (DE) 10 2012 215 887.1

(51) Int. Cl. F16J 15/34; F16J 15/38

(52) U.S. Cl. CPC F16J 15/3464; F16J 15/38

(57) ABSTRACT

An arrangement having a gas seal, a stator and a rotor extending along an axis for sealing a sealing gap between the rotor and the stator, including a rotating rotor sealing ring and a static stator sealing ring, comprising a rotating fixing element, which axially fixes the rotor sealing ring at the rotor is provided.

### CROSS-REFERENCE TO RELATED APPLICATIONS

This application claims priority to PCT Application No. PCT/EP2013/065687, having a filing date of Jul. 25, 2013, based off of DE 102012215887.1 having a filing date of Sep. 7, 2012, the entire contents of which are hereby incorporated by reference.

### FIELD OF TECHNOLOGY

The following relates to an arrangement with a gas seal, a stator and a rotor which extends along an axis for sealing a sealing gap between the rotor and the stator, comprising a rotating rotor sealing ring and a static stator sealing ring, furthermore comprising a rotating fastening element which fixes the rotor sealing ring axially on the rotor.

### BACKGROUND

Gas seals are the preferred seal form as a consequence of the comparatively low leakage at relatively high pressures for continuous-flow machines, in particular, compressors which are configured as turbomachines. For example, in comparison with the conventional labyrinth seal, the leakage of the dry gas seal which is lower by an order of magnitude makes a significant increase in the degree of efficiency of the corresponding turbomachine possible.

In comparison with the labyrinth seals which are of comparatively simple construction, the modern dry gas seals are comparatively exacting with regard to the operating conditions. Reliable operation requires a correspondingly prepared and purified seal gas. Furthermore, dry gas seals depend on a defined minimum rotational speed for reliable operation.

In the gas seals which were mentioned at the outset, a rotating rotor sealing ring and a stationary stator sealing ring as a rule lie opposite one another on a radially extending sealing plane with in each case one sealing face on the sealing rings. In order that the sealing principle can be implemented successfully, it is necessary for the sealing faces of the two sealing rings to be machined precisely and oriented with respect to one another, with the result that a sliding film of the sealing gas is built up between the sealing faces under reproducible operating conditions and the seals can correspondingly operate in a contactless manner. The high precision requirements under all conceivable operating conditions are achieved as a rule only by way of a special material selection. The rotating and the stationary stator sealing ring are therefore regularly not connected integrally to the rotor and the stator, the stationary stator sealing ring also regularly being braced elastically against the rotating rotor sealing ring. The rotating rotor sealing ring is fixed on the rotor, in order that uncontrolled relative movements, in particular in the axial direction, do not occur. In conventional sealing arrangements, fretting at the axial contact between the rotating rotor sealing ring and a corresponding axial contact shoulder of the rotor frequently occurs, since conventional arrangements make an axial relative movement possible.

DE 10 2012 215887 discloses the simultaneous axial fastening and sealing of a sliding ring on the rotor. DE 41 19 768 A 1 discloses a gas seal with two spiral grooves which run in opposite directions, one sliding ring rotating in an elastically sprung manner with the shaft and the associated corresponding ring being of stationary configuration. DE 102010041 208 A1 is concerned with a static sealing element.

Accordingly, a solution which prevents fretting has up to now been neither known nor implemented.

### SUMMARY

An aspect relates to securing the rotating rotor sealing ring of the gas seal mentioned at the outset axially on the rotor against excitations in such a way that no fretting can occur.

All directional indications, such as axial, radial, circumferential direction or tangential, relate to the rotor axis, unless specified otherwise.

The fastening element according to embodiments of the invention ensures reliable axial fixing of the rotating rotor sealing ring on the rotor. Here, the rotor means not only exclusively a solid single-piece shaft, but rather also means rotating constituent parts, for example, of a sealing module which can preferably be pushed onto the rotor in a sleeve-like manner and can be secured axially there.

One particular advantage of embodiments of the invention lies in the very simple mounting of the rotating rotor sealing ring on the rotor by means of elastic radial deformation of the fastening element, with the result that mounting can be made possible even without a tool. The mounting of the rotating rotor sealing ring on the rotor is likewise reversible. The permanent radial and axial bracing of the rotating rotor sealing ring on the rotor at the same time ensures a radial orientation of the rotating rotor sealing ring with respect to the rotor. Furthermore, any excitations from the rotor on the rotor sealing ring are damped in a sprung manner by way of the fastening element.

One advantageous development of embodiments of the invention provides that the deformation of the fastening element does not take place plastically, but rather preferably takes place elastically. It is preferred here that the deformation of the fastening element takes place exclusively in the elastic deformation range of the material of the fastening element.

The fastening element particularly appropriately extends over the entire circumference of the rotor or the rotating sealing element, with the result that any asymmetries are avoided and no unbalance can be produced either.

In a further preferred embodiment, the fastening element is configured as a helix ring. Experience has shown that a helically shaped spring meets the requirements of radial deformability as satisfactorily as possible. The helix of the fastening element preferably consists of a flat section and is particularly preferably made from steel, in particular from stainless steel. For applications, in which aggressive gases play a role, in particular hydrogen sulfide, it is expedient if the material of the fastening element is sour gas resistant.

It is fundamentally expedient if the depressions on the rotor and the rotating rotor sealing ring extend over the entire circumference, just like the fastening element which is arranged partially in said depressions and braces the rotating rotor sealing ring in the manner of a combined positively locking connection and force fit with the rotor. The arrangement is preferably configured in such a way that a stationary auxiliary sealing element is included which seals the rotating rotor sealing ring against the rotor on a rotor shoulder, the auxiliary sealing element exerting an axial prestressing force on the rotating rotor sealing ring. It is appropriate here if a restoring force from the elastic deformation of the fastening element counteracts said axial prestressing force of the auxiliary sealing element, the restoring force of the fastening element counter to an axial relative displacement out of the setpoint position of the rotating rotor sealing ring being higher than the prestressing force of the auxiliary sealing element.

The fastening element is particularly preferably designed in such a way that the restoring force from the elastic deformation of the fastening element exceeds the sum of the axial prestressing force of the auxiliary sealing element and the inertial force from the excitation of the rotor sealing ring from tolerable axial eccentricities of the rotor during operation (that is to say, at the nominal rotational speed).

One advantageous development provides that the first depression and/or the second depression are/is delimited axially on both sides over at least part of the circumference by in each case one radial projection. As a result, the fastening element holds the rotor sealing ring at a predefined axial position on the rotor.

In addition or, in particular, as an alternative, it is appropriate if the fastening element is prestressed or deformed elastically in the setpoint position range of the rotating rotor sealing ring and the rotor with respect to one another and the elastically generated restoring force presses the rotor sealing ring against a shaft shoulder or individual contact shoulders on the shaft or the rotor or a shaft sleeve, with the result that the rotor sealing ring is situated in a position which is axially defined unambiguously by way of said contact.

The fastening element is preferably the only element of the fastening which fastens the rotor sealing ring with an axial force.

In order to avoid fretting, it is preferred that the fastening element is deformed radially elastically when the rotating rotor sealing ring and the rotor are situated with respect to one another in the setpoint position range, in such a way that the perpendicular force on the surfaces of the depressions which results from the elastic deformation gives rise to a resulting frictional force between the surfaces and the fastening element, which frictional force transmits a torque which arises during operation from the rotor sealing ring to the rotor.

One refinement of embodiments of the invention is particularly preferred, in which the fastening element is arranged partially in the first depression and partially in the second depression, in such a way that an axial relative movement beyond a setpoint position range between the rotating rotor sealing ring and the rotor is possible only via a radial deformation of the fastening element, and in such a way that dismantling of the rotor sealing ring from the rotor is possible by means of said radial deformation.

### BRIEF DESCRIPTION

Some of the embodiments will be described in detail, with reference to the following figures, wherein like designations denote like members, wherein:

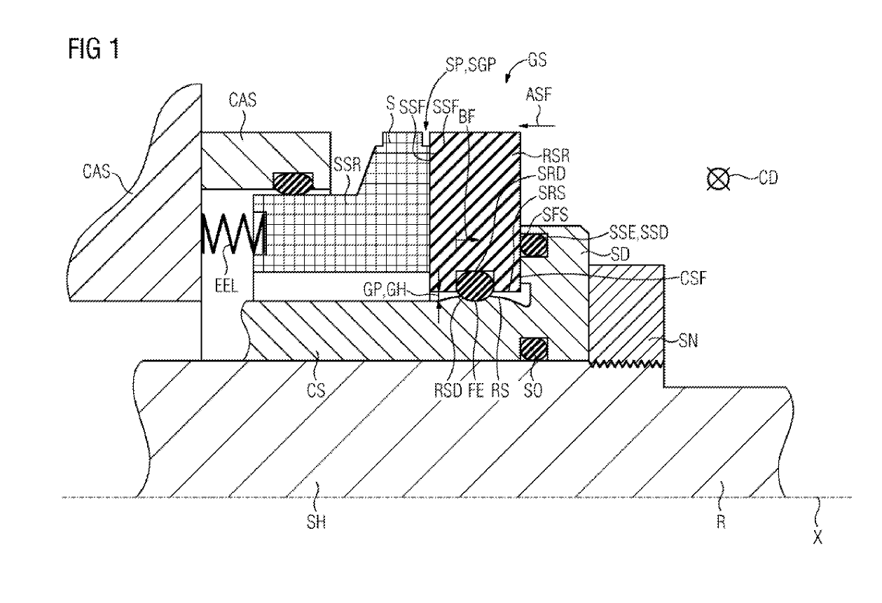

FIG. 1 shows a diagrammatic illustration of a longitudinal section through an embodiment of an arrangement with a gas seal; and

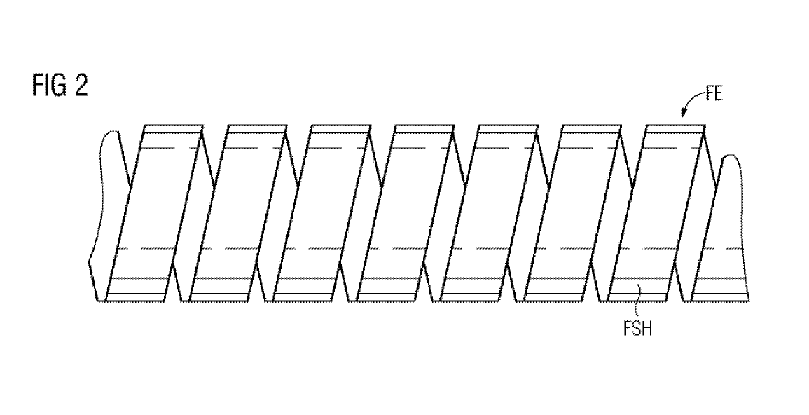

FIG. 2 shows a diagrammatic illustration of a circumferential section of an embodiment of a fastening element.

### DETAILED DESCRIPTION

FIG. 1 shows a diagrammatic illustration of a longitudinal section through an arrangement according to the invention with a gas seal GS. The gas seal GS comprises a stator S and a rotor R. Decisive elements of the stator S are the static stator sealing ring SSR, an elastic element EL and a housing component CAS. Important elements of the rotor R are the shaft SH, a carrier sleeve CS, a shaft nut SN and a rotating rotor sealing ring RSR. The carrier sleeve CS extends along an axis X coaxially with respect to the shaft SH and is secured axially on the shaft SH against a shaft shoulder (not shown) by means of the shaft nut SN. A seal SO seals a remaining gap between the shaft SH and the carrier sleeve CS. The carrier sleeve CS has a radially projecting shoulder SD with an axial contact face CSF. The axial contact face CSF has a recess SSD which serves to receive a stationary secondary sealing element SSE. The stationary secondary sealing element SSE bears against a contact face SSF of the rotating rotor sealing ring RSR. The secondary sealing element SSE is pressed axially between the carrier sleeve CS and the rotating sealing element RSR by way of the contact face SFS of the rotating rotor sealing ring RSR by a prestressing force of the elastic element EEL and a fastening element FE. Here, an axial contact between the rotating rotor sealing ring RSR and the stationary stator sealing ring SSR also occurs at a standstill in a sealing plane SP, at which the sealing faces SSF of the rotating rotor sealing ring RSR and the stationary stator sealing ring SSR lie opposite one another.

The fastening element FE is arranged in the region of a gap GP between the carrier sleeve CS of the rotor R and the rotating rotor sealing ring RSR. The gap GP has a radial gap height GH. The rotating rotor sealing ring RSR is provided with a first depression SRD on the sealing ring surface SRS which points radially inward to the rotor R, and the rotor R or the carrier sleeve CS is provided with a second depression RSD on the opposite side, in which depressions SRD, RSG the fastening element FE is in each case radially partially arranged. The depressions RSD, SRD extend in the circumferential direction, just like the fastening element FE. During operation, the rotating rotor sealing ring RSR is situated in an axial setpoint position and can only be moved out of said setpoint position range with an axial relative movement between the rotating rotor sealing ring RSR and the carrier sleeve CS or the rest of the rotor R with radial deformation of the fastening element FE on account of the respectively partially radial arrangement in the depressions RSD and SRD. This deformation of the fastening element FE takes place exclusively elastically with the production of a restoring force BF which is correspondingly directed counter to said relative movement, radial components of deformation forces of the movement element FE being absorbed by the rotating rotor sealing ring RSR as a result of the annular shape of the rotating rotor sealing ring RSR. Together with the fastening element FE, the depressions are adapted in such a way that an axial prestressing force from the fastening element FE permanently prestresses the stationary secondary seal SSE in an opposite direction to an axial prestressing force ASF from the stationary secondary sealing element SSE.

FIG. 2 shows a circumferential section of the fastening element FE in a diagrammatic illustration. The fastening element FE is configured as a flat steel helix which extends in the circumferential direction. The material is sour gas resistant.

The helix structure of the fastening element FE which is shown in FIG. 2 has the additional advantage that not only does axial fixing of the rotating rotor sealing ring RSR on the rotor R take place, but rather also fixing in the circumferential direction. If the rotating rotor sealing ring RSR is loaded with a torque which is suitable for changing the position in the circumferential direction relative to the rotor R, the prestress in the radial direction on the fastening element FE ensures that the edges of the flat section or the edges of the flat steel section which is wound to form a helix are supported in each case on the rotor R or the rotating rotor sealing ring RSR and in this way prevent a relative movement.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. An arrangement with a gas seal, a stator and a rotor which extends along an axis for sealing a sealing gap between the rotor and the stator, comprising;
a rotating rotor sealing ring;
a static stator sealing ring; and
a rotating fastening element that fixes the rotating rotor sealing ring axially on the rotor, the fastening element extending at least over a part of a circumference in a circumferential direction, and being arranged at least partially in a gap of a radial gap height that extends axially and in the circumferential direction between the rotor and the rotating rotor sealing ring, the gap being defined on a side of the rotating rotor sealing ring by a sealing ring surface and on a side of the rotor by a rotor surface, the sealing ring surface having a first depression and the rotor surface having a second depression;
wherein the fastening element is arranged in the first depression and partially in the second depression, in such a way that an axial relative movement beyond a setpoint position range between the rotating rotor sealing ring and the rotor is possible only via a radial deformation of the fastening element.

2. The arrangement as claimed in claim 1, wherein the fastening element is of a radially elastically deformable configuration, with the result that the fastening element deforms elastically during the axial relative movement beyond the setpoint position range.

3. The arrangement as claimed in claim 2, wherein the fastening element deforms exclusively elastically during the axial relative movement beyond the setpoint position range.

4. The arrangement as claimed in claim 1, wherein the fastening element extends over the entire circumference.

5. The arrangement as claimed in claim 1, wherein the fastening element is configured as a flat section helix.

6. The arrangement as claimed in claim 1, further comprising a stationary auxiliary sealing element that seals the rotating rotor sealing ring against the rotor on a rotor shoulder, the stationary secondary sealing element exerting an axial prestressing force on the rotating rotor sealing ring.

7. The arrangement as claimed in claim 6, wherein the fastening element is of elastic configuration in such a way that it generates an axial restoring force counter to an axial relative displacement out of the setpoint position, the axial restoring force being higher than the axial prestressing force of the stationary secondary sealing element.

8. The arrangement as claimed in claim 5, wherein the fastening element comprises a flat steel helix.

9. The arrangement as claimed in claim 8, wherein a material of the flat steel helix is sour gas resistant.

10. The arrangement as claimed in claim 1, wherein the first depression and/or the second depression is delimited axially on both sides over at least part of the circumference by, in each case, one radial projection.

11. The arrangement as claimed in claim 1, wherein the fastening element is deformed radially elastically when the rotating rotor sealing ring and the rotor are situated with respect to one another in the setpoint position range, in such a way that a perpendicular force on the surfaces of the first depression and the second depression that results from the elastic deformation gives rise to a resulting frictional force between the surfaces and the fastening element, which frictional force transmits a torque which arises during operation from the rotor sealing ring to the rotor.
